(19) United States
(12) Patent Application Publication
(10) Pub. No.: US 2017/0134379 A1
(43) Pub. Date: May 11, 2017

(54) METHOD FOR SECURING AN APPLICATION AND DATA

(71) Applicant: POLYVALOR, LIMITED PARTNERSHIP, Montreal (CA)

(72) Inventors: Gabriela NICOLESCU, Beaconsfield (CA); Bogdan NICOLESCU, Beaconsfield (CA)

(73) Assignee: POLYVALOR, LIMTED PARTNERSHIP, Montreal, QC (CA)

(21) Appl. No.: 15/319,396

(22) PCT Filed: Jun. 8, 2015
(86) PCT No.: PCT/CA2015/000366

§ 371 Date: Dec. 16, 2016

Related U.S. Application Data
(60) Provisional application No. 62/012,458, filed on Jun. 16, 2014.

(51) Int. Cl. H04L 29/06; G06F 21/54; H04L 9/08; G06F 21/14

(52) U.S. Cl. CPC H04L 63/0876; G06F 21/14; G06F 21/54; H04L 63/061; H04L 9/0869; G06F 2221/2107

(57) ABSTRACT

The present disclosure relates to methods for securing an application. A first method generates a unique cipher for securing the application, by performing iterations of: inputting a random number corresponding to a pre-defined operation, inputting at least one operand, and executing instructions for applying the pre-defined operation to the at least one operand. A second method secures an application by means of a multi-threaded cipher, which executes a ciphering function as a plurality of threads. Two threads of the ciphering function are performed in synchronicity. A third method secures an application by means of a multi-level cipher. The application is secured by applying an application cipher part and an OS cipher part. A fourth method secures an application by means of a multi-level security function. The application is secured by executing an application part security function and an OS part security function.

### TECHNICAL FIELD

The present disclosure relates to the field of software security. More specifically, the present disclosure relates to methods for securing an application and/or data generated by the application.

### BACKGROUND

Data ciphering is used in a plurality of contexts where sensitive data need to be protected from reading, alteration, copy, etc. Data ciphering includes a first step where the sensitive data are encrypted at a first entity (e.g. a computing device, a server, etc.). The encrypted data are then transmitted to a second entity (e.g. another computing device, another server, etc.). Data ciphering includes a second step where the encrypted data are decrypted at the second entity to recover the sensitive data. The recovered sensitive data can then be processed at the second entity.

Data ciphering can be used to secure an application, for instance by using a cipher to encrypt/decrypt data generated by the execution of the application.

Data ciphering is based on the encryption/decryption of the sensitive data by encryption keys (e.g. symmetric keys or asymmetric public/private keys). The strength of a cipher (aka a ciphering algorithm) depends on several parameters, including the length of the ciphering key(s), the algorithm for generating the ciphering key(s), etc. However, it has been proven in the past that ciphers, which could supposedly not be tampered, were in fact vulnerable to tampering attacks. One type of attack consists in brute force attack, where the advances in computing technologies provide enough processing power to break a cipher that could not be broken in the past due to a lack of adequate processing power. Another type of attack consists in retro-engineering of ciphers. For instance, by studying published data about a cipher, an attacker can find vulnerability in the cipher and use it to break it. Alternatively, by analyzing the execution by a processor of software instructions implementing a cipher, an attacker can determine how the cipher operates and use this knowledge to break it.

Although a lot of efforts and knowledge in the cryptographic field have been dedicated to designing robust ciphers, there is no warranty that any cipher is a hundred percent safe. Furthermore, most of the efforts have been concentrated on the cryptographic aspects of ciphers. However, adding complexity to the execution of a cipher by a processing unit of a computing device improves its robustness, by making it more difficult for an attacker to retro-engineer the cipher.

Therefore, there is a need for new methods for securing an application, including new methods of using a cipher to protect an application.

### SUMMARY

In accordance with a first aspect, the present disclosure relates to a method for securing data by means of a unique cipher. The method comprises generating the unique cipher by a processing unit, by performing at least one iteration of: inputting a random number, the random number corresponding to a pre-defined operation stored in memory; inputting at least one operand; and executing instructions for applying the pre-defined operation to the at least one operand.

In accordance with a second aspect, the present disclosure relates to a method for securing data by means of a multi-threaded cipher. The method comprises executing, by a processing unit, a ciphering function as a plurality of threads. Each thread comprises instructions, that when executed by the processing unit, apply parts of the cipher to secure the data. Two threads of the ciphering function may be performed in synchronicity.

In accordance with a third aspect, the present disclosure relates to a method for securing an application and/or data generated by the application by means of a multi-level cipher. The method comprises executing, by a processing unit, securing instructions independently stored in the application and in an operating system (OS) running the application. The securing instructions stored in the application generate an application cipher part and the securing instructions stored in the OS generate an OS cipher part. The application and/or the data generated by the application is/are secured by applying the application cipher part and the OS cipher part.

In accordance with a fourth aspect, the present disclosure relates to a method for securing an application by means of a multi-level security function(s). The method comprises executing, by a processing unit, securing instructions independently stored in the application and in an operating system (OS) running the application. The securing instructions stored in the application provide an application part security function and the securing instructions stored in the OS provide an OS part security function. The application is secured by executing the application part security functions and the OS part security function(s).

### BRIEF DESCRIPTION OF THE DRAWINGS

Embodiments of the disclosure will be described by way of example only with reference to the accompanying drawings, in which:

FIG. 1 illustrates computing devices for carrying out ciphering operations;

FIG. 2 illustrates a decompilation of a set of instructions;

FIG. 3 illustrates an array of pre-defined arithmetic operators for generating a unique cipher;

FIG. 4 illustrates multi-threaded ciphering operations;

FIG. 5 illustrates software layers of a computing device for protecting an application by means of a multi-level cipher;

FIGS. 6 and 7 illustrate an execution flow of an application protected with securing instructions stored in the application;

FIG. 8 illustrates the generation of a protected application starting from its binary code;

FIG. 9 illustrates an execution flow of an application protected with securing instructions stored in OS services;

FIG. 10 illustrates an execution flow of an application protected with securing instructions stored in an OS kernel; and

FIG. 11 illustrates a multi-level cipher in a cloud environment.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

The following terminology is used throughout the present disclosure:

Cipher: a cipher (or ciphering algorithm) is an algorithm for performing encryption or decryption of data. Encryption and decryption are complementary operations: source data are first encrypted (by an encryption cipher) and the encrypted data are later decrypted (by a complementary decryption cipher) to recover the source data. Ciphers are distinguished by the type of key used: symmetric key algorithms where the same key is used for encryption and decryption, and asymmetric key algorithms where two different keys are used for encryption and decryption. Ciphers are also distinguished by the type of input data: block ciphers which encrypt block of data of fixed size, and stream ciphers which encrypt continuous streams of data.

Application: a computer program (also referred to as a software program) comprising instructions that when executed by a processing unit of a computing device performs a specific task on the computing device (e.g. implement a method on the computing device). The instructions of the computer program are referred to as the binary code of the computer program. In the present disclosure, the term application refers to a computer program that can be secured via different means detailed in the following.

Multi-threading: in the context of the present specification, the expression ‘multi-threading’ refers to multiple threads executed from different entities, such as the application and the OS. The threads located outside the protected application are not visible (accessible) from the application. The protected application does not know that it is protected from outside, and there is no communication from the application to the protectors located in the OS.

The present disclosure specifically addresses the usage of ciphers to secure data such as applications, in particular to prevent tampering of the binary code of an application, and the data generated by the application. When in clear, the binary code of an application and/or of the data generated by the application can be retro-engineered by an attacker. For instance, by analyzing any particular set of instructions of the binary code, the attacker is capable of determining the purpose of this particular set of instructions or data. Then, the attacker can modify this particular set of instructions or the data generated by the particular set of instructions, so that when executed on a processing unit of a computing device, an unexpected action is performed to the benefit of the attacker (e.g. retrieving sensitive data generated or received by the application, and transmitting these sensitive data to a remote computing device under the control of the attacker). In the following, several methods for securing an application and/or data generated by the application are described.

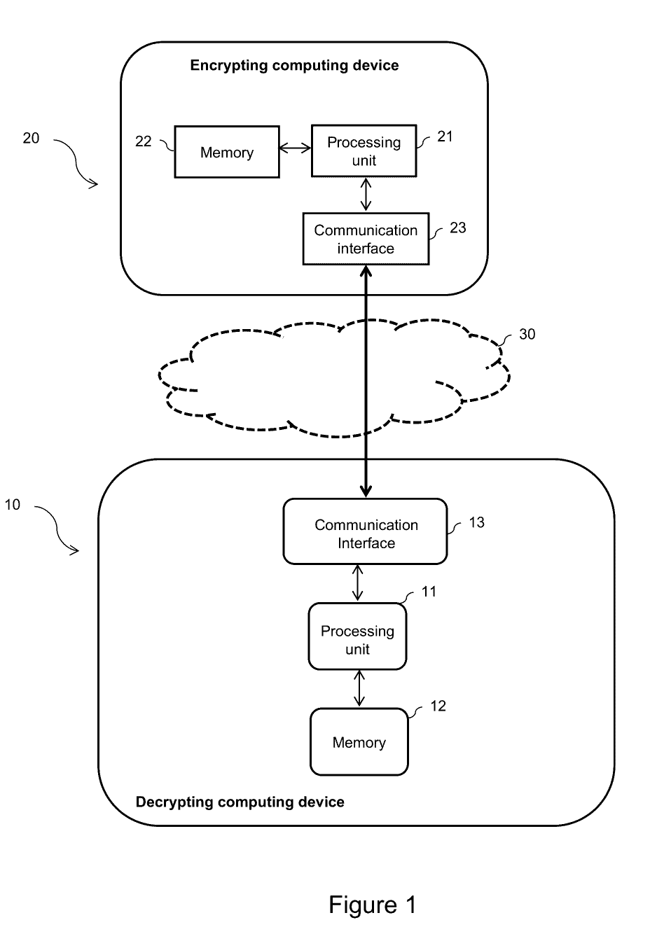

Referring now to FIG. 1, computing devices 10 and 20 for implementing methods for securing an application and/or data generated by the application are represented.

The computing device 10 comprises a processing unit 11, having one or more processors (not represented in FIG. 1) capable of executing instructions of a computer program. Each processor may further have one or several cores. The computing device 10 also comprises memory 12 for storing instructions of the computer program, data generated by the execution of the computer program, etc. Only a single memory 12 is represented in FIG. 1, but the computing device 10 may comprise several types of memories, including volatile memory (such as a volatile Random Access Memory (RAM)) and non-volatile memory (such as a hard drive). Furthermore, although the memory 12 is shown as a separate entity from the processing unit 11, those skilled in the art will understand that the memory could be integral with the processing unit 11. The computing device 20 is similar to the computing device 10 and also comprises a processing unit 21 and memory 22, and again, the memory 22 could alternately be integral with the processing unit 21.

The computing devices 10 and 20 further comprise a communication interface (respectively 13 and 23) for exchanging data with other entities through communication links 30 (e.g. a cellular network, a fixed Internet network, etc.). In particular, the computing devices 10 and 20 exchange data between each other through the communication links 30.

Instructions of a security program implement the steps of a method for securing the application and/or data generated by the application. The instructions are comprised in a computer program product and provide for securing the application and/or data generated by the application, when executed by a processor of the processing units 11 or 21 of the computing devices 10 or 20. The instructions of the computer program product are deliverable via an electronically-readable media such as a storage media (e.g. a USB key, a CD-ROM, a portable hard drive, etc.) or via the communication links 30 (through the communication interfaces 13 or 23). When the method for securing the application and/or data generated by the application includes applying a cipher, the computing device 20 is referred to as the encrypting computing device and applies an encryption cipher, while the computing device 10 is referred to as the decrypting computing device and applies a complementary decryption cipher.

The computing devices 10 and 20 represented in FIG. 1 are for exemplary purposes only, and are not intended to limit the scope of the present disclosure. Examples of computing devices 10 and 20 include servers, desktops, laptops, tablets, smartphones, connected home appliances (e.g. televisions, decoders, modems, access points, etc.), etc.

### Method for Binary Code Obfuscation

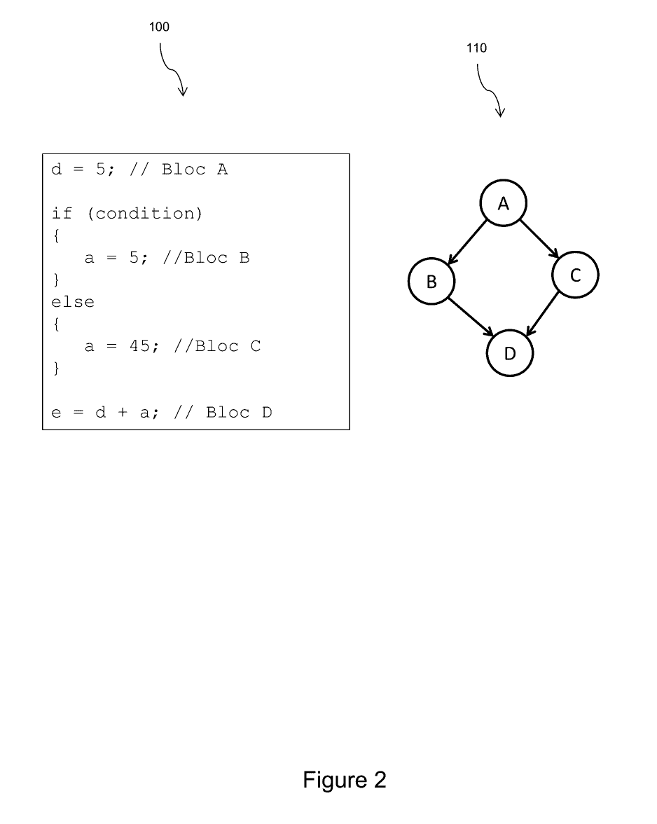

Referring now concurrently to FIGS. 1 and 2, a method for binary code obfuscation is described.

The method comprises decompilation of an original binary code, followed by an insertion of additional instructions in the original binary code to obfuscate it (and thus make it less understandable by an attacker).

The binary code of an application consists of base instructions and control instructions. Base instructions compose basic blocks of instructions that execute sequentially. Control instructions are instructions with the capability to change the control flow (e.g. jumps, conditions, calls and return instructions) of the application.

The decompilation step consists in identifying all basic blocks and their relationships (by identifying control instructions linking the basic blocks together). FIG. 2 represents of a set of instructions 100 with four identified basic blocks (A, B, C and D). FIG. 2 also represents the relationships 110 between the basic blocs (A, B, C and D).

The second step consisting in inserting additional instructions in order to obfuscate the binary code may be performed in several ways. For instance, new instructions may be added to existing basic blocks or additional basic blocks with new instructions may be added. Alternatively or complementarily, existing control instructions may be modified or new control instructions may be added to alter the relationships between the basic blocks. However, the inserted additional instructions only add complexity to the execution of the application, without modifying the specific task performed by the application.

Referring to FIG. 2, the set of instructions 100 comprises the control instruction: if (condition). Assuming the value of condition is a variable c1, the control instruction is altered by changing the value of condition to c1·c2+c2′, where c2 and c2′ are variables introduced to complicate the condition evaluation. Instructions can be further added to basic block A to affect the values 1 to c2 and 0 to c2′. Thus, the altered set of instructions 100 performs the same task as the original set of instructions 100, but in a more complex manner due to the introduction of additional instructions.

Instructions of a security program implement the steps of the method for binary code obfuscation. The instructions are comprised in a computer program product and provide for binary code obfuscation, when executed by a processing unit (e.g. 21 or 11) of a computing device (e.g. 20 or 10).

Although the concept of binary obfuscation has been described in the context of instructions of an application, those skilled in the art will appreciate that the concept of binary obfuscation could also be used for inserting unnecessary bits to data generated by the application.

Method for Securing an Application and/or Data Generated by the Application by Means of a Unique Cipher

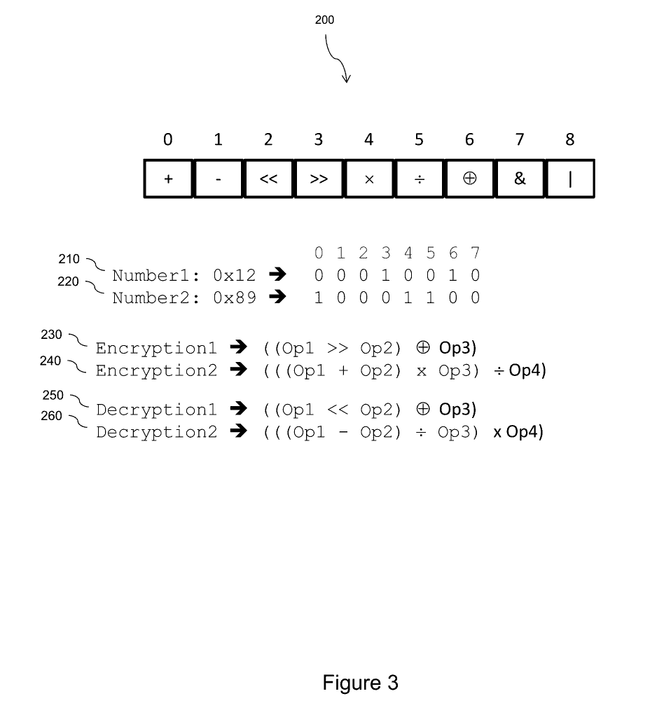

Referring now concurrently to FIGS. 1 and 3, a method for securing an application and/or data generated by the application by means of a unique cipher is described.

The method automatically generates a unique cipher for encrypting an application and/or data generated by the application that needs to be secured. The method relies on randomly choosing operations (and optionally operands) to generate the encryption cipher. A complementary cipher for decrypting the application and/or data generated by the application is also generated, and consists of complementary operations from those used to generate the encryption cipher. Since a unique cipher is generated and used to secure a specific application and/or data generated by the specific application, an attacker succeeding in breaking the security of this specific application and/or data cannot use this knowledge to break the security of another application and/or data protected by another unique cipher.

The method comprises generating the unique cipher by a processing unit (e.g. 11 or 21) of a computing device (e.g. 10 or 20) by performing at least one iteration of the following steps.

The step of inputting a random number corresponding to a pre-defined operation: a memory (e.g. 12 or 22) of the computing device (e.g. 10 or 20) stores a plurality of pre-defined operations, and the random number uniquely identifies one among the plurality of pre-defined operations. Alternatively, the memory (e.g. 12 or 22) may store a plurality of pre-defined operators, and the random number uniquely identifies a combination of at least one among the plurality of pre-defined operators, to generate the pre-defined operation.

The step of inputting at least one operand.

The step of executing instructions for applying the pre-defined operation to the at least one operand.

The unique cipher consists of an encryption cipher generated at the encrypting computing device 20: inputting the random number consists in generating the random number by the processing unit 21 and inputting the at least one operand consists in retrieving the operand(s) from the memory 22 where it is stored.

The unique cipher also consists of a complementary decryption cipher generated at the decrypting computing device 10. Data encrypted with the encryption cipher at the encrypting computing device 20 are decrypted with the complementary decryption cipher at the decrypting computing device 10. Inputting the random number consists in receiving the random number generated at the computing device 20 via the communication interface 13. The random number is transmitted from the computing device 20 to the computing device 10 via the communication interfaces 23 and 13 through the communication links 30, in a secure manner. The received random number is stored in the memory 12 of the computing device 10, and used at any time for generating the unique decryption cipher. The unique decryption cipher may be generated by the application, by the OS, or by a combination thereof. Similarly, inputting the at least one operand consists in receiving (via the communication interface 13) operand(s) used at the computing device 20 for generating the encryption cipher. The received operand(s) is stored in the memory 12 of the computing device 10, and used at any time for generating the unique decryption cipher.

The plurality of pre-defined operations may be stored for example in an array in a memory (e.g. 12 or 22). The random number is an index of the array and identifies a particular operation among the plurality of operations. Other methods for correlating the random number to pre-defined operations could alternately be used.

The pre-defined operation consists in a combination of at least one of the following arithmetic operators: addition, subtraction, multiplication, division, bit shifting, logical negation, logical and, logical inclusive or, and logical exclusive or, etc.

The plurality of pre-defined arithmetic operators may also be stored in an array in a memory (e.g. 12 or 22). The random number corresponds to at least one index of the array and identifies at least one particular arithmetic operator among the plurality of arithmetic operators, as will be illustrated later in relation to FIG. 3. Other methods for correlating the random number to pre-defined arithmetic operators could alternately be used.

The operand consists of one of the following: a block of instructions of an application to secure, a block of data generated by the execution by a processing unit of instructions of an application to secure, a block of bits of a ciphering key, etc.

The generated unique cipher is used for securing an application by encrypting a binary code of the application. For instance, at the encrypting computing device 20, some or each iteration of the method consists in applying a pre-defined operation to one of, or a combination of, the following operands: a block of instructions of the binary code of the application to secure, and a block of bits of a ciphering key.

The generated unique cipher is used for securing an application by decrypting an encrypted binary code of the application. For instance, at the decrypting computing device 10, each iteration of the method consists in applying a pre-defined operation (complementary to the encrypting pre-defined operation) to one of, or a combination of, the following operands: a block of encrypted instructions of the binary code of the application to secure, and a block of bits of a ciphering key.

The generated unique cipher is also used for securing an application by encrypting data generated by the application. For instance, at the encrypting computing device 20, each iteration of the method consists in applying a pre-defined operation to one of, or a combination of, the following operands: a block of data generated by the execution by the processing unit 21 of instructions of the application to secure, and a block of bits of a ciphering key.

The generated unique cipher is also used for securing an application by decrypting encrypted data of the application. For instance, at the decrypting computing device 10, some or each iteration of the method consists in applying a pre-defined operation (complementary to the encrypting pre-defined operation) to one of, or a combination of, the following operands: a block of encrypted data of the application, and a block of bits of a ciphering key. The block of encrypted data of the application has been generated by the secured application executed on the computing device 20, encrypted on the computing device 20, and transmitted to the computing device 10.

The term ciphering key is used generically for a key used for generating and applying an encryption cipher as well as a decryption cipher. It may be a symmetric or an asymmetric ciphering key.

The processing unit (e.g. 11 or 21) generally performs a plurality of iterations for generating the unique cipher. For instance, the binary code of an application to be secured can be divided into N blocks of bits, and the processing unit may perform N iterations to generate the unique cipher. At each iteration, one of the N blocks of bits is inputted as an operand. Furthermore, the result of applying the pre-defined operation to the at least one operand for one iteration is an operand for another iteration.

Applying the pre-defined operation to the at least one operand may consist in applying the pre-defined operation to a single operand (e.g. a logical negation of an operand). It may also consist in applying the pre-defined operation to more than one operand (e.g. a logical and between two operands, the addition of three operands, etc.).

In the case where the predefined operation consists in a combination of pre-defined operators (e.g. arithmetic operators), the pre-defined operation is generally applied to several operands (e.g. addition of a first operand with a second operand, followed by the subtraction of a third operand).

FIG. 3 illustrates the generation of encryption and decryption ciphers, where the pre-defined operations consist in combinations of pre-defined arithmetic operators. The array 200 represented in FIG. 3 comprises the following pre-defined arithmetic operators: addition at index 0, subtraction at index 1, left bit shifting at index 2, right bit shifting at index 3, multiplication at index 4, division at index 5, logical exclusive or at index 6, logical and at index 7, and logical negation at index 8. The arithmetic operators represented in FIG. 3 are for illustration purposes only. Additional or different operators may be used, the order of the operators may be different, the operators may be organized in a different manner, etc. A first random number 210 is inputted, having the value 0x12, which corresponds to index 3 and 6 of the array 200. Thus, the corresponding operation is a combination of a right bit shifting and a logical exclusive or. A second random number 220 is inputted, having the value 0x89, which corresponds to index 0, 4 and 5 of the array 200. Thus, the corresponding operation is a combination of an addition, a multiplication and a division.

A first iteration 230 of the generation of the encryption cipher consists in inputting the first random number 210, inputting operands Op1, Op2, and Op3, and applying the corresponding operation to the inputted operands. A second iteration 240 of the generation of the encryption cipher consists in inputting the second random number 220, inputting operands Op1, Op2, Op3 and Op4, and applying the corresponding operation to the inputted operands. The encryption cipher is generated at the encrypting computing device 20.

A first iteration 250 of the generation of the decryption cipher consists in inputting the first random number 210, inputting operands Op1, Op2, and Op3, and applying the corresponding operation to the inputted operands. The corresponding operation consists of a combination of arithmetic operators complementary to those used at iteration 210 for the encryption cipher. A second iteration 260 of the generation of the decryption cipher consists in inputting the second random number 220, inputting operands Op1, Op2, Op3 and Op4, and applying the corresponding operation to the inputted operands. The corresponding operation consists of a combination of arithmetic operators complementary to those used at iteration 220 for the encryption cipher. The decryption cipher is generated at the decrypting computing device 10.

In a particular aspect, the method also comprises inputting another random number for selecting an operand among a plurality of operands based on the other random number. All the inputted operands are selected based on random numbers. Alternatively, only a subset of the inputted operands is selected based on random numbers. For instance, a ciphering key is decomposed into a plurality of blocks of bits used as operands for the cipher. At a particular iteration of the method, the operation applies to an operand, consisting of a blocks of bits of the ciphering key selected, based on the other random number. Similarly, the binary code of an application is decomposed into a plurality of blocks of bits used as operands for the cipher. At a particular iteration of the method, the operation is applied to an operand consisting of a blocks of bits of the binary code selected based on the other random number. In this particular aspect, the selection of the blocks of bits based on random numbers shall ensure that when all the iterations of the method have been performed, all the blocks of bits of the binary code have been processed by the cipher.

The other random number is used to determine which among the plurality of blocks of bits shall be used at a particular step of the ciphering algorithm

In another particular aspect, ciphering keys used by the cipher are randomly generated, before being decomposed into a plurality of blocks of bits used as operands for the cipher.

In still another particular aspect, the aforementioned method for binary code obfuscation is applied before applying the current method for securing an application by means of a unique cipher. For instance, the binary code of an application and/or to be secured is obfuscated according to the aforementioned method, before generating a unique encryption cipher and applying it to the obfuscated binary code according to the current method.

Instructions of a security program implement the steps of the method for securing an application by means of a unique cipher. The instructions are comprised in a computer program product and provide for securing the application and/or data generated by the application by means of the unique cipher, when executed by a processing unit (e.g. 21 or 11) of a computing device (e.g. 20 or 10).

Method for Securing an Application and/or Data Generated by the Application by Means of a Multi-threaded Cipher

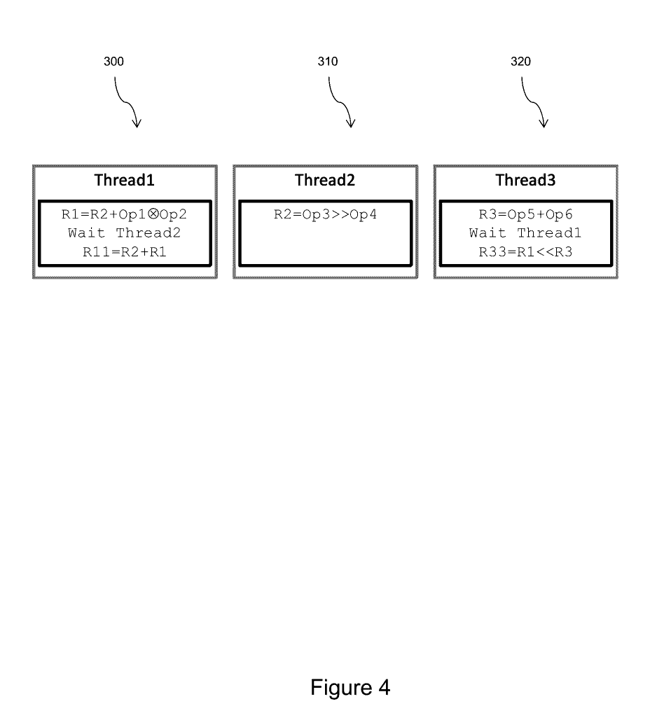

Referring now concurrently to FIGS. 1 and 4, a method for securing an application and/or data generated by the application by means of a multi-threaded cipher is described.

The method divides the execution by a processing unit of instructions for securing the application and/or data generated by the application by applying the cipher into complementary threads. The threads are designed so that they need to synchronize in order to provide the final outcome of the application of the cipher. The synchronization of the threads is performed without using Operating System (OS) thread synchronization services. By using a plurality of threads, an analysis of the ciphering operations becomes more difficult for an attacker, since debugging multi-threaded applications with a large degree of synchronization is far more difficult in comparison with applications executing as a single thread. In particular, white-box attacks are less effective in a multi-threaded environment. A white-box attack consists in having the ciphering operations under the control of a debugger, allowing attackers to observe the run-time ciphering operations. Thus, it is generally a matter of time before attackers manage to understand the ciphering algorithm and/or seize the secured content.

The method consists in executing by a processing unit (e.g. 11 or 21) of a computing device (e.g. 10 or 20) a ciphering function as a plurality of threads. Each thread comprises instructions that when executed by the processing unit (e.g. 11 or 21) apply parts of the cipher to secure the application and/or data generated by the application. Two threads of the ciphering function are performed in synchronicity.

A particular thread can be synchronized with a single or with a plurality of other threads. A particular thread can have several different points of synchronization with another particular thread. All the threads may be synchronized with each other, or particular threads may not be synchronized with other threads.

The synchronization may consist in suspending a first thread until a second thread terminates. Alternatively or complementarily, the synchronization may consist in suspending a first thread until data is received from a second thread.

Applying the cipher to secure the application and/or data generated by the application consists in encrypting a binary code of the application and/or of the data generated by the application. The application of the cipher is performed on an encrypting computing device 20, which then transfers the encrypted binary code to a decrypting computing device 10.

Applying the cipher to secure the application consists in decrypting a binary code of the application and/or of the data generated by the application. The application of the cipher is performed on the decrypting computing device 10, which then executes the secured application after decryption of its binary code.

Applying the cipher to secure the application also consist in encrypting data generated by the execution of the application. Executing the application and applying the cipher is performed on an encrypting computing device 20, which then transfers the encrypted data to a decrypting computing device 10.

Applying the cipher to secure the application also consists in decrypting encrypted data of the application. Applying the cipher is performed on the decrypting computing device 10, which has received the encrypted data from the encrypting computing device 20.

FIG. 4 illustrates the execution of a ciphering function being divided between three synchronized threads 300, 310 and 320. The first thread 300 suspends its execution to wait for the calculation of R2 by the second thread 310, before calculating R1. The first thread 300 also suspends its execution until the termination of the second thread 310, before calculating R11. The second thread 310 is independent of the other threads. The third thread 320 suspends its execution until the termination of the first thread 300, before calculating R33. The final outcome of the ciphering function is R33, calculated by the third thread 320.

Any number of threads may be launched for executing the ciphering function. In particular, some of the threads may perform no operation related to the cipher, but may be present only to make it more difficult for an attacker to understand the relationships and synchronizations between the threads. The plurality of threads may be launched concurrently and may execute in parallel. Alternatively, the plurality of threads may be launched at different moments in time.

In a particular aspect, the plurality of threads belongs to a plurality of processes running in different memory spaces.

In another particular aspect, the cipher applied by the current method for securing an application by means of a multi-threaded cipher consists in the unique cipher generated by the aforementioned method for securing an application by means of a unique cipher. Hence, the execution of the instructions of at least one of the plurality of threads comprises performing at least one iteration of: inputting a random number corresponding to a pre-defined operation, inputting at least one operand, and executing instructions for applying the pre-defined operation to the at least one operand.

Instructions of a security program implement the steps of the method for securing an application by means of a multi-threaded cipher. The instructions are comprised in a computer program product and provide for protecting the application by means of the multi-threaded cipher, when executed by a processing unit (e.g. 21 or 11) of a computing device (e.g. 20 or 10).

Method for Securing an Application and/or Data Generated by the Application by Means of a Multi-Level Security Functions

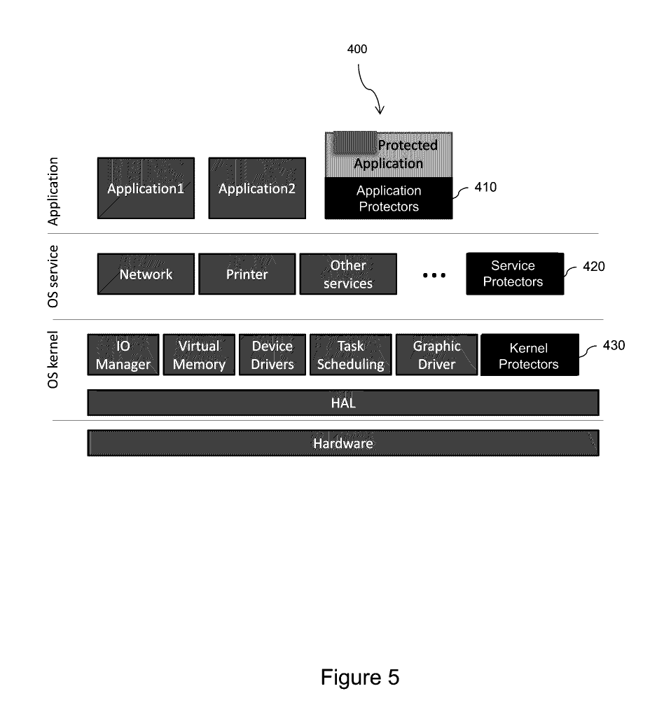

Referring now concurrently to FIGS. 1 and 5, a method for securing an application and/or data generated by the application by means of a multi-level security function is described.

The method divides the execution by a processing unit of instructions for securing the application into securing instructions included into the application itself (for applying an application part security functions), and into securing instructions included into an operating system (OS) running the application (for applying an OS part security functions). This method provides an advantage over software security techniques using a self-protection principle only, which means that protectors are embedded into the protected application only. Conversely, self-protection techniques cannot provide a high level of protection due to the fact that protectors are enabled later in the execution flow of the application. For example, launching an application developed in the C programing language requires four stages: loading the binary code of the application from disk into memory, C Run-Time (CRT) libraries initialization (required for lower-level functions such as printf, malloc, etc.), dependency resolution (loading necessary libraries), and starting the execution of the binary code of the application. In the case of self-protection techniques, the security operations are disabled during the first two stages (which are executed by the OS), and can only be applied from the third stage (which is executed by the application to secure).

The method consists in executing by a processing unit (e.g. 11 or 21) of a computing device (e.g. 10 or 20) securing instructions independently stored in the application to secure and in an operating system (OS) running the application to secure. The securing instructions stored in the application provide an application part security function and the securing instructions stored in the OS provide an OS part security function. The application is secured by executing the application part security function and the OS part security function.

The securing instructions stored in the OS may include OS kernel instructions, OS services instructions, or a combination of OS kernel instructions and OS services instructions. OS kernel instructions protect operations performed by the kernel of the OS (e.g. Input/Output management, virtual memory management, task scheduling, graphic driver management). OS services instructions protect operations performed by the services of the OS (e.g. network management, printer management, etc.).

FIG. 5 illustrates exemplary software layers of a computing device (e.g. 10 or 20) for securing an application 400 by means of a multi-level security software. The software layers include OS kernel securing instructions for securing the application 400 with an OS part security function 430, OS services securing instructions for securing the application 400 with an OS services part security function 420, and application securing instructions for securing the application 400 with one or several application part security functions 410 (although only one is shown on FIG. 5 for simplicity purposes).

The different levels of securing instructions (e.g. application level, OS services level and OS kernel level) are configured to work in a stand-alone mode, or in a collaborative mode. The securing instructions at the OS level (e.g. kernel and services) are active all the time, since they are loaded by the OS at boot time. Therefore, these securing instructions can protect the application (e.g. 400) from the earliest stage. This enables application protection as soon as the application is loaded into memory on the computing device.

The application part security function 410 includes one or more application protectors, each protector providing particular security functionality. Similarly, the OS services part security function 420 includes one or more service protectors, and the OS kernel part security function 430 includes one or more kernel protectors. Examples of protectors include: binary code obfuscation, binary code integrity verification (verification that the binary code has not been modified), binary code debug prevention (preventing a dynamic analysis of the execution of the binary code), license verification (verification that a license attached to the binary code is authentic), module authentication (verification that third-party libraries loaded for executing the binary code are authentic), binary code decryption, etc. Each type of protector may be executed at the application level, at the service level or at the kernel level.

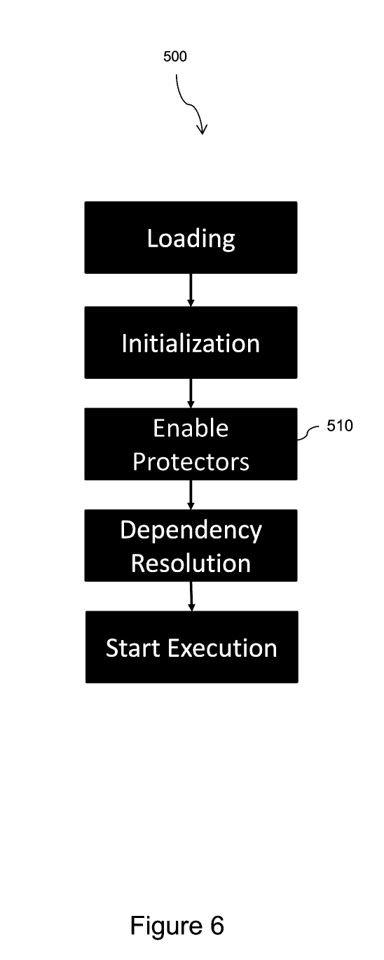

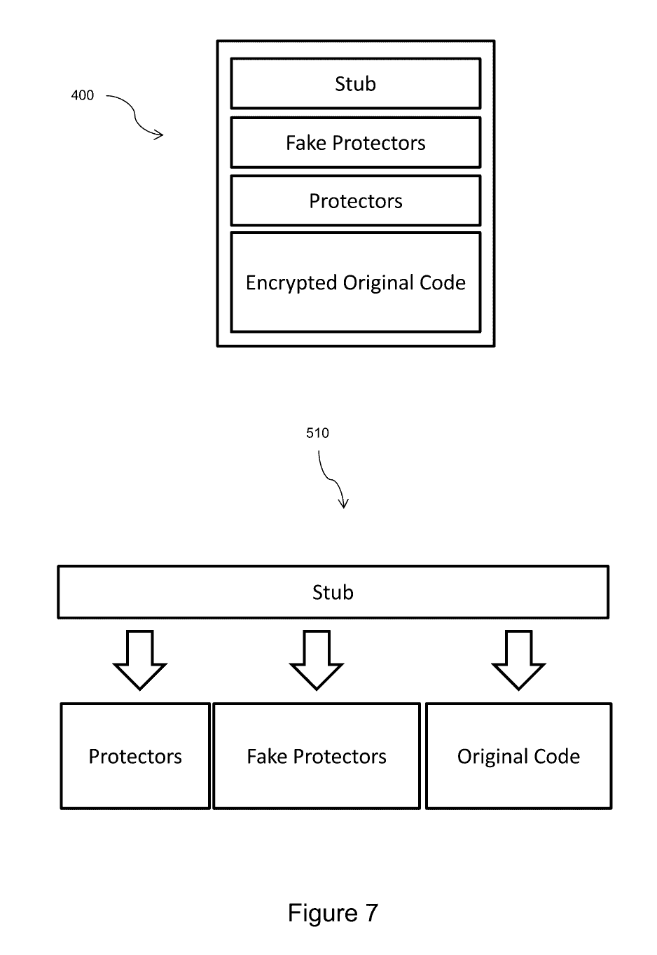

FIGS. 6 and 7 illustrate an execution flow 500 of an application 400 protected with securing instructions stored in the application. The application 400 stores the following components: a stub, fake protectors for misleading an attacker, application protectors, and the encrypted original binary code of the application.

The application is first loaded from disk into memory and initialized. Then, the securing instructions 510 are executed. For instance, as illustrated in FIG. 7, the stub is executed first. The stub performs preliminary security checks, installs the fake protectors and the application protectors, and decrypts the encrypted original binary code of the application. Then, dependency resolution is performed and the execution of the decrypted original binary code of the application is started. The fake protectors and the application protectors are executed as separate threads that run concurrently with the original binary code of the application.

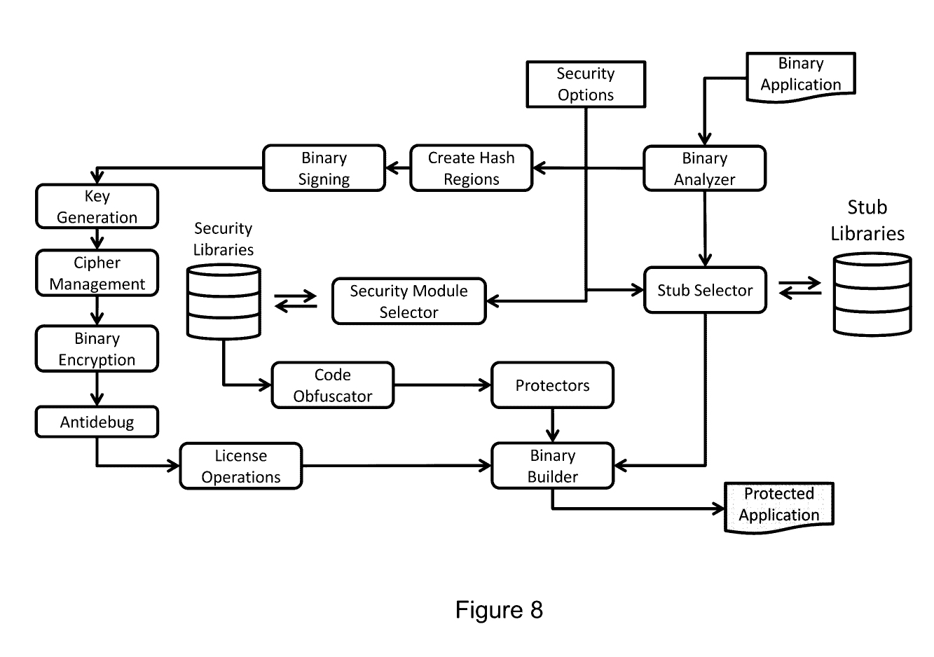

FIG. 8 illustrates the generation of a protected application, starting from the binary code of the application. A stub is selected from a stub library and integrated to the protected application. A plurality of protectors are selected from a security library and also integrated to the protected application. The binary code is signed, encrypted (using a unique cypher as previously discussed) and enhanced with debug prevention and license verification features. Code obfuscation is applied to the protectors, and may also be applied to the binary code. The resulting protected application can be used by the present method for securing an application by means of a multi-level security function, for implementing the application level security function.

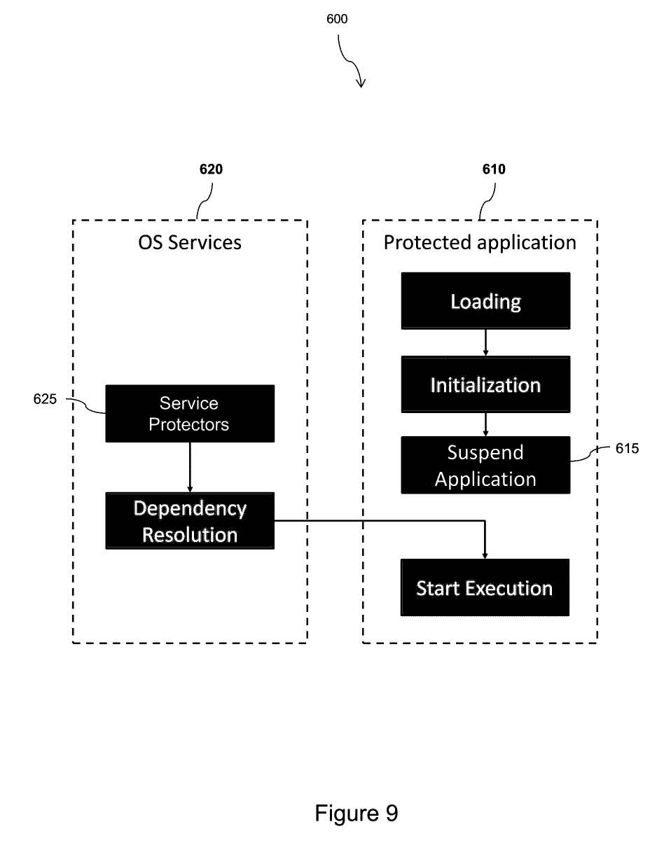

FIG. 9 illustrates an execution flow 600 of an application 610 protected with securing instructions 625 stored in the OS services 620. The securing instructions 625 in the OS services 620 are running all the time and are constantly scanning applications currently run by the OS, to identify protected applications (e.g. 610). The protected application 610 is first loaded from disk into memory and initialized, and then puts itself into suspend mode 615. The securing instructions 625 detect the suspended application 610 and perform security operations specific to the OS services 620, by executing one or more service protectors. Examples of security functionalities executed by the service protectors include decryption, fixing relocation tables, other dependency resolutions, etc. The execution of the binary code of the protected application 610 is then started. The securing instructions 625 may perform additional security operations while the secured application 610 is running. When the secured application 610 terminates its execution, the securing instructions 625 remain active (to secure other applications which are still run by the OS).

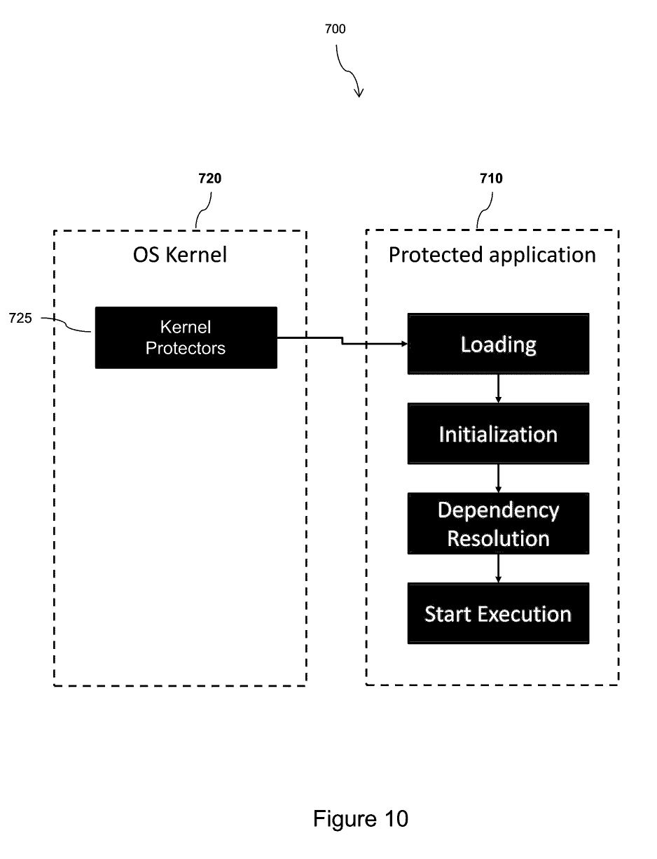

FIG. 10 illustrates an execution flow 700 of an application 710 protected with securing instructions 725 stored in the OS kernel 720. The securing instructions 725 in the OS kernel 720 are running all the time and are constantly scanning applications currently run by the OS, to identify protected applications (e.g. 710). The protected application 710 is first loaded from disk into memory and then immediately put into suspend mode. The securing instructions 725 detect the suspended application 710 and perform security operations specific to the OS kernel 720, by executing one or more kernel protectors. Examples of security functionalities executed by the kernel protectors include decryption, fixing relocation tables, other dependency resolutions, etc. The secured application 710 is then initialized, additional dependency resolutions may be performed, and execution of the binary code of the protected application 710 is started. The securing instructions 725 may perform additional security operations while the secured application 710 is running. When the secured application 710 terminates its execution, the securing instructions 725 remain active (to secure other applications which are still run by the OS).

Although the securing instructions 510 of the application in FIG. 6, the securing instructions 625 of the OS services in FIG. 9, and the securing instructions 725 of the OS kernel in FIG. 10 have been described independently, these securing instructions may be running concurrently to implement the multi-level protection of the application to secure.

In a particular aspect, the current method for securing an application by means of a multi-level security function is combined with a multi-threaded execution of the multi-level security function. Hence, securing the application by executing the application part security function and/or the OS part security function comprises: executing, by the processing unit, the application part security function or the OS part security function as a plurality of threads, with at least two threads being performed in synchronicity. Only the application part security function is executed as a plurality of synchronized threads, only the OS part security function is executed as a plurality of synchronized threads, or both the application part and the OS part security functions are executed as a plurality of synchronized threads (in the latter case, threads for the application part and the OS part are synchronized independently of one another, or are also synchronized with one another).

Instructions of a security program implement the steps of the method for securing an application by means of a multi-level security function. The instructions are comprised in a computer program product and provide for protecting the application by means of the multi-level security function, when executed by a processing unit (e.g. 21 or 11) of a computing device (e.g. 20 or 10).

### Multi-Level Security Function in a Cloud Environment

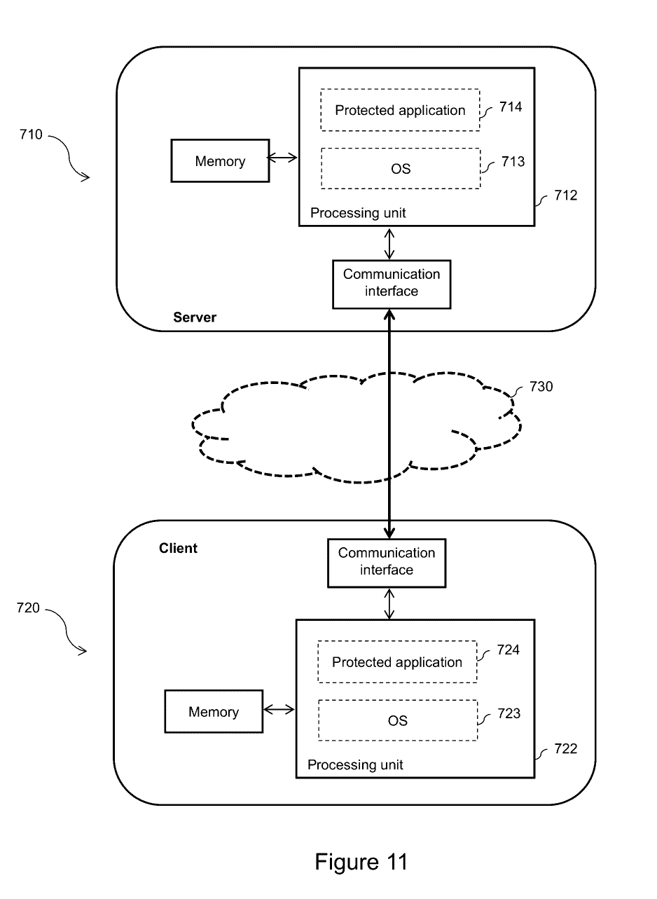

Referring now to FIG. 11, a cloud environment is illustrated, where a server 710 and a client 720 communicate via their respective communication interfaces through communication links 730 (e.g. a cellular network, a fixed Internet network, etc.).

A processing unit 712 of the server 710 executes instruction of the server part 714 (e.g. calculations) of a protected application and a processing unit 722 of the client 720 executes a client part 724 (e.g. a user interface) of the same protected application. The processing unit 712 also executes instructions of a server OS 713 and the processing unit 722 also executes instructions of a client OS 723.

Securing instructions stored in the client part 724 of the protected application apply a client part security function when executed by the processing unit 722 and securing instructions stored in the server OS 713 apply a server OS part security function when executed by the processing unit 712. Optionally, securing instructions stored in the client OS 723 also apply a client OS part security function when executed by the processing unit 722. Optionally, securing instructions stored in the server part 714 of the protected application also apply a server application part security function when executed by the processing unit 712

Other combinations of securing instructions respectively stored in the client part 724 of the protected application for applying a client application part security function, in the server OS 713 for applying a server OS part security function, in the client OS 723 for applying a client OS part security function, and in the server part 714 of the protected application for applying a server application part security function may also be considered by a person skilled in the art.

Method for Securing an Application and/or Data Generated by the Application by Means of a Multi-Level Cipher

Referring now concurrently to FIGS. 1 and 5, a method for securing an application and/or data generated by the application by means of a multi-level cipher is described.

The method divides the execution by a processing unit of instructions for securing the application into securing instructions included into the application itself (for applying an application cipher part), and into securing instructions included into an operating system (OS) running the application (for applying an OS cipher part).

The method consists in executing by a processing unit (e.g. 11 or 21) of a computing device (e.g. 10 or 20) securing instructions independently stored in the application to secure and in an operating system (OS) running the application to secure. The securing instructions stored in the application generate an application cipher part and the securing instructions stored in the OS generate an OS cipher part. The application is secured by applying the application cipher part and the OS cipher part.

The securing instructions stored in the OS may include OS kernel instructions for generating an OS kernel cipher part, OS services instructions for generating an OS services cipher part, or a combination of OS kernel instructions and OS services instructions. OS kernel instructions protect operations performed by the kernel of the OS. OS services instructions protect operations performed by the services of the OS.

FIG. 5 illustrates exemplary software layers of a computing device (e.g. 10 or 20) for securing an application 400 by means of a multi-level cipher. The software layers include OS kernel securing instructions for securing the application 400 with an OS kernel cipher part 430, OS services securing instructions for securing the application 400 with an OS services cipher part 420, and application securing instructions for securing the application 400 with an application cipher part 410.

The different levels of securing instructions (e.g. application level, OS services level and OS kernel level) are configured to work in a stand-alone mode, or in a collaborative mode. The securing instructions at the OS level (e.g. kernel and services) are active all the time, since they are loaded by the OS at boot time. Therefore, these securing instructions can protect the application (e.g. 400) from the earliest stage. This enables application protection as soon as the application is loaded into memory on the computing device.

FIG. 6 illustrates an execution flow 500 of an application protected with securing instruction stored in the application. The application stores the following components: the securing instructions, optionally fake securing instructions for misleading an attacker, and the encrypted original binary code of the application.

The application is first loaded from disk into memory and initialized. Then the securing instructions 510 are executed. For instance, the securing instructions 510 apply an application cipher part for decrypting the encrypted original binary code of the application. Then, dependency resolution is performed and the execution of the decrypted original binary code of the application is started.

FIG. 9 illustrates an execution flow 600 of an application 610 protected with securing instructions 625 stored in the OS services 620. The securing instructions 625 in the OS services 620 are running all the time and are constantly scanning applications currently run by the OS, to identify protected applications (e.g. 610). The protected application 610 is first loaded from disk into memory and initialized, and then puts itself into suspend mode 615. The securing instructions 625 detect the suspended application 610 and perform security operations specific to the OS services 620. For instance, the securing instructions 625 apply an OS services cipher part for decrypting the encrypted original binary code of the application 610. The execution of the decrypted original binary code of the protected application 610 is then started. When the secured application 610 terminates its execution, the securing instructions 625 remain active (to secure other applications which are still run by the OS).

FIG. 10 illustrates an execution flow 700 of an application 710 protected with securing instructions 725 stored in the OS kernel 720. The securing instructions 725 in the OS kernel 720 are running all the time and are constantly scanning applications currently run by the OS, to identify protected applications (e.g. 710). The protected application 710 is first loaded from disk into memory and then immediately put into suspend mode. The securing instructions 725 detect the suspended application 710 and perform security operations specific to the OS kernel 720. For instance, the securing instructions 725 apply an OS kernel cipher part for decrypting the encrypted original binary code of the application 710. The secured application 710 is then initialized, dependency resolution is performed, and execution of the decrypted original binary code of the protected application 710 is started. When the secured application 710 terminates its execution, the securing instructions 725 remain active (to secure other applications which are still run by the OS).

Although the securing instructions 510 of the application in FIG. 6, the securing instructions 625 of the OS services in FIG. 9, and the securing instructions 725 of the OS kernel in FIG. 10 have been described independently, these securing instructions may be running concurrently to implement the multi-level protection of the application to secure.

As illustrated previously, securing the application by applying the application cipher part and the OS cipher part consists in decrypting a binary code of the application. The application of the cipher is performed on a decrypting computing device 10, which then executes the secured application after decryption of its binary code.

Securing the application by applying the application cipher part and/or the OS cipher part also consist in encrypting data generated by the execution of the application. The data is generated at the application level and/or at the OS level, and are encrypted by the corresponding cipher part. Executing the application and applying the cipher is performed on an encrypting computing device 20, which then transfers the encrypted data to a decrypting computing device 10.

In a particular aspect, the cipher applied by the current method for securing an application by means of a multi-level cipher consists in the unique cipher generated by the aforementioned method for securing an application by means of a unique cipher. Hence, securing the application by applying the application cipher part and/or the OS cipher part comprises performing at least one iteration of: inputting a random number corresponding to a pre-defined operation, inputting at least one operand, and executing instructions for applying the pre-defined operation to the at least one operand.

In another particular aspect, the current method for securing an application by means of a multi-level cipher is combined with the aforementioned method for securing an application by means of a multi-threaded cipher. Hence, securing the application by applying the application cipher part and/or the OS cipher part comprises: executing, by the processing unit, the application cipher part or the OS cipher part as a plurality of threads, with at least two threads being performed in synchronicity. Only the application cipher part is executed as a plurality of synchronized threads, only the OS cipher part is executed as a plurality of synchronized threads, or both the application cipher part and the OS cipher part is executed as a plurality of synchronized threads (in this case, threads for each cipher part is synchronized independently of the other cipher part, or are also synchronized with the other cipher part).

Instructions of a security program implement the steps of the method for securing an application by means of a multi-level cipher. The instructions are comprised in a computer program product and provide for protecting the application by means of the multi-level cipher, when executed by a processing unit (e.g. 21 or 11) of a computing device (e.g. 20 or 10).

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for securing an application by means of a unique cipher, the method comprising:
generating the unique cipher by a processing unit by performing at least one iteration of:
inputting a random number, the random number corresponding to a pre-defined operation;
inputting at least one operand; and
executing instructions for applying the pre-defined operation to the at least one operand.

2. The method of claim 1, wherein the pre-defined operation consists in a combination of at least one of the following arithmetic operators: addition, subtraction, multiplication, division, bit shifting, logical negation, logical and, logical inclusive or, and logical exclusive or.

3. The method of claim 1, wherein the operand consists in one of the following: a block of instructions of an application to secure, a block of data generated by the execution by a processing unit of instructions of an application to secure, and a block of bits of a ciphering key.

4. The method of claim 1, wherein the processing unit performs a plurality of iterations, and the result of applying the pre-defined operation to the at least one operand for one iteration is an operand for another iteration.

5. The method of claim 1, wherein the generated unique cipher is used for one of the following: securing an application by encrypting a binary code of the application, or securing an application by decrypting a binary code of the application.

6. The method of claim 1, further comprising:
inputting another random number and selecting the operand among a plurality of operands based on the other random number.

7. A method for securing an application by means of a multi-threaded cipher, the method comprising:
executing, by a processing unit, a ciphering function as a plurality of threads, each thread comprising instructions that when executed by the processing unit apply parts of the cipher to secure the application;
wherein two threads of the ciphering function are performed in synchronicity.

8. The method of claim 7, wherein applying parts of the cipher to secure the application consists in one of the following: encrypting a binary code of the application, or decrypting a binary code of the application.

9. The method of claim 7, wherein performing two threads of the ciphering function in synchronicity consists in one of the following: suspending a first thread until a second thread terminates, or suspending a first thread until data is received from a second thread.

10. The method of claim 7, wherein executing instructions by the processing unit for applying parts of the cipher to secure the application comprises:
performing at least one iteration of:
inputting a random number, the random number corresponding to a pre-defined operation;
inputting at least one operand; and
executing instructions for applying the pre-defined operation to the at least one operand.

11. A method for securing an application by means of a multi-level cipher, the method comprising:
executing by a processing unit securing instructions independently stored in the application and in an operating system (OS) running the application, the securing instructions stored in the application generating an application cipher part and the securing instructions stored in the OS generating an OS cipher part; and
securing the application by applying the application cipher part and the OS cipher part.

12. The method of claim 11, wherein the securing instructions stored in the OS comprise at least one of the following: OS kernel instructions, and OS services instructions.

13. The method of claim 11, wherein securing the application by applying the application cipher part or the OS cipher part consists in decrypting a binary code of the application.

14. The method of claim 11, wherein securing the application by applying the application cipher part or the OS cipher part comprises:
performing at least one iteration of:
inputting a random number, the random number corresponding to a pre-defined operation;
inputting at least one operand; and
executing instructions for applying the pre-defined operation to the at least one operand.

15. The method of claim 11, wherein securing the application by applying the application cipher part or the OS cipher part comprises:
executing, by the processing unit, the application cipher part or the OS cipher part as a plurality of threads;
wherein two threads are performed in synchronicity.

16. A method for securing an application by means of a multi-level security function, the method comprising:
executing by a processing unit securing instructions independently stored in the application and in an operating system (OS) running the application, the securing instructions stored in the application providing an application part security function and the securing instructions stored in the OS providing an OS part security function; and
securing the application by executing the application part security function and the OS part security function.

17. The method of claim 16, wherein the securing instructions stored in the OS comprise at least one of the following: OS kernel instructions, and OS services instructions.

18. The method of claim 16, wherein securing the application by executing the application part security function or the OS part security function consists in at least one of the following: binary code obfuscation, binary code integrity verification, binary code debug prevention, license verification, module authentication, and binary code decryption.

19. The method of claim 16, wherein securing the application by executing the application part security function or the OS part security function comprises:
executing, by the processing unit, the application part security function or the OS part security function as a plurality of threads;
wherein two threads are performed in synchronicity.
